(19) United States
(12) Patent Application Publication
(10) Pub. No.: US 2013/0225701 A1
(43) Pub. Date: Aug. 29, 2013

(54) GRAFTING METHOD TO IMPROVE CHROMATOGRAPHY MEDIA PERFORMANCE

(71) Applicants: Neil Soice, Groton, MA (US); Joaquin Umana, Reading, MA (US); Yu Zhang, Chelmsford, MA (US)

(72) Inventors: Neil Soice, Groton, MA (US); Joaquin Umana, Reading, MA (US); Yu Zhang, Chelmsford, MA (US)

(73) Assignee: EMD MILLIPORE CORPORATION, Billerica, MA (US)

(21) Appl. No.: 13/812,965

(22) PCT Filed: Jul. 29, 2010
(86) PCT No.: PCT/US2010/002119

§ 371 Date: May 1, 2013

(51) Int. Cl. B01J 39/00

(52) U.S. Cl. CPC B01J 39/00
USPC 521/31

(57) ABSTRACT

The invention relates to improved methods of grafting polymer extenders onto porous substrates having diffusive pores, such as those used in protein separations, without filing the diffusive pores of the substrate, and restricting diffusion there through. By changing the grafting conditions and/or monomer composition(s) the resulting porous substrates having polymer extenders grafted thereto have increased protein binding capacity and resin selectivity, thereby enhancing the protein separation effectiveness of the substrate. The grafted polymer extenders provide the substrate with significant binding capacity at higher conductivity. The invention also relates to kits, and methods of using and grafting polymer extenders on porous resin substrates having diffusive pores.

### RELATED APPLICATIONS

The present application claims is a U.S. National Stage Application of International Patent Application No. PCT/US2020/02119, International Filing Date of Jul. 29, 2010 the entire contents of which are incorporated herein in its entirety.

### FIELD OF THE INVENTION

The present invention relates to improved methods for grafting polymer extenders. The invention also relates to improvements in the method of grafting polymer extenders onto porous substrates used in protein separations, resulting in porous substrates having improved protein binding capacity and resin selectivity, as well as kits and methods relating to making and using the same.

### BACKGROUND OF THE INVENTION

Therapeutic protons produced from living organisms play an increasingly important role in modern healthcare. These proteins provide many advantages over traditional pharmaceuticals, including increased specificity and efficacy towards disease targets. Mammalian immune systems use a range of proteins, IgA, IgD, IgE, IgG and IgM, to control and eliminate disease threats. The advent of genetic and protein engineering has allowed the development of many “designed” or recombinant protein therapeutics. These therapeutics can be based on a single protein, chemically modified protein, protein fragment or protein conjugate. One subclass of these therapeutic proteins, monoclonal antibodies (MAbs), has found a wide range of applications in healthcare and diagnostics. Chromatographic separations are extensively utilized in the manufacturing of these biopharmaceuticals. As the industry matures, implementation of novel/advanced technologies and methods to enhance separations will provide biotherapeutic producers the ability to provide these medicines to more patients and at lower cost.

Common chromatography methods used to purify proteins include affinity, bioaffinity, ion exchange, reversed phase, hydrophobic interaction, hydrophilic interaction, size exclusion and mixed mode (combinations of the aforementioned categories) among others. The application and efficiency of each of those types of chromatography procedures relies on the selectivity of surface-surface interactions between the solute molecules and the stationary phase of the chromatography system (chromatography media), each interaction with the mobile liquid phase. A wide variety of stationary phase chromatography support materials are commercially available.

Often the key to a successful separation of product from impurities relies on the correct combination of stationary phase base matrix and ligand properties (ligand type, ligand density, pore structure, ligand distribution, material composition), and mobile phase or solution properties (buffer type, pH and conductivity). The specific design of the base matrix and ligand results in a chromatography media which can be characterized by several key attributes including protein binding capacity or throughput, selectivity, bed permeability and chemical stability. Purification methods include predominately binding the product (bind and elute), predominately binding the impurities (flow-through) and combinations of the aforementioned (so called weak partitioning and others). It is critical in the design of these technologies to control the chromatography media properties taught above in order to enable and ensure a robust separation leading to purified protein product.

Protein separations can be accomplished on a variety of porous substrates or base matrices. Common materials for resin or bead structures include polysaccharides (agarose, cellulose), synthetic polymers (polystyrene, polymethacrylate and polyacrylamide) and ceramics such as silica, zirconia and controlled pore glass. These materials adsorb proteins via “diffusive pores” are typically about 200 Å to 3,000 Å, much smaller than the “convective pores” which are typically about >5 μm, which control bed permeability and are formed by interbead spaces in a packed bed.

Membrane and monolith materials are also commonly used for chromatography particularly flow-through applications. Typical membrane compositions include synthetic polymers such as polyvinylidenefluoride, polyethylene, polyethersulfone, nylon, and polysaccharides such as cellulose.

Monoliths have been developed from polystyrene, polysaccharides and many other synthetic polymers. Membrane and monolith chromatography differs from beads in that these materials adsorb proteins in the same “convective pores” which control the membrane and monolith material's permeability. Typical membrane and monolith convective pore sizes range from about 0.6 μm to about 10 μm. Ligand addition to these substrates can be accomplished through a variety of well developed techniques.

The use of ligand “tentacles” or “extenders” to improve protein binding capacity and modify resin selectivity involves placing a ligand on polymer chains coupled to a base matrix such as by grafting, and extend away from the base matrix surface. Ligand extenders typically create greater binding capacity because the extenders increase ligand availability where target molecule binding exceeds that of a monolayer adsorption on the surface. For example, the preparation of surface modified porous silica materials for use as ion-exchangers is taught in Jansen et al., “Absorption of Proteins on Porous and Non-Porous Poly(ethyleneimine) and Tentacle-Type Anion Exchangers”, (Journal of Chromatography, vol. 522, 1990, 77-93), the disclosure of which is hereby incorporated by reference.

Two standard methodologies for grafting polymer extenders have been developed for creating surface extenders on porous substrates such as those used in chromatography for protein separation and the like: 1) grafting of monomers from a support via a surface radical (“grafting monomers from”), and 2) grafting a preformed polymer to a support via an activating group (“grafting polymers to”).

One early method for coupling extenders to a resin was by grafting polymer chains from the base matrix surface following initiation of monomer polymerization with metal/oxidization generated radicals typically resulted in a greater than 50% increase in the protein binding capacity (See for example, U.S. Pat. No. 5,453,186 to Muller). Several other approaches have been developed including grafting to a base matrix surface with dextrans (See, for example, U.S. Pat. No. 6,428,707 to Berg), grafting with highly branched polymers (See, for example, WO 2004/003542 to Amersham Bioscience), and grafting with hydrophobic polymers (See, for example, WO 2005/098415 to GE Healthcare Bio-Sciences). The disclosure of each of these U.S. patents and published international patent applications is hereby incorporated by reference.

For example, grafting hydrophobic polymers to a base resin as taught in WO 05/098415, modifies the protein selectivity of a resin, compared to simple surface bound ligands. Each of these modifications add polymeric chains to the base matrix surface either by “grafting monomers from” the surface (initiation of radical polymerization) or “grafting polymers to” the surface (attachment of preformed polymer.

Grafting monomers from porous materials using radical polymerization reactions is a well developed technology. In general, the reaction can be initiated from a porous surface material or from an initiator in solution.

Initiating the radical polymerization from the surface can be accomplished by generating radicals at the surface via exposure to reactive environments such as radiation, metal oxidation and adsorbed initiating species (See for example, “Polymer Surfaces”, Fabio Garbassi, John Wiley-Sons Inc., New York, 1998). However, these “grafting monomers from” approaches require very controlled solution conditions and/or special equipment which make their implementation complicated and time consuming.

When the reaction is initiated from solution, attachment of a surface reactive group to the surface prior to grafting is necessary to enable a permanent linkage between the newly formed polymer and the surface of the porous material. Typically, the surface reactive group is capable of further polymerization with the monomers in solution (e.g., a similar type of monomer, such as an attached acrylate anchoring a forming acrylate polymer). However, due to degradative chain transfer radical polymerization is limited, and allylic monomers, such as allyl glycidyl ether (AGE), are preferably not used. (See for example, “Principles of Polymerization”, George Odian, John Wiley-Sons Inc., New York, 1991), the disclosure of which is hereby incorporated by reference.

However, it is known to use allyl functionalities as a surface reactive group. For example, allylic surface reactive groups can be used to modify cellulose fibers or silica which can be used to form porous structures (so called “jelly rolls”) having pore sizes >1 mm, and permitting efficient convective flow (>200 mL/min). (See for example, U.S. Pat. Nos. 4,663,163 and 4,724,207, each to Hou). The disclosure of each of these U.S. patents is hereby incorporated by reference.

Alternatively, an acrylamide can be polymerized and attached to an agarose matrix (e.g., 15% wt agarose), whereby protein diffusion into the matrix is effectively reduced such that the agarose matrix having the polymerized acrylamide attached thereto is useful for HPLC applications (HPLC applications use non-porous beads in order to maximize analyte resolution). (See, for example, U.S. Pat. No. 5,135,650 to Hjerten), the disclosure of which is hereby incorporated by reference.

However, neither Hou nor Hjerten teach or suggest polymerizing an acrylamide or monomer coupled to the surface of a porous chromatography support having diffusive pores, wherein the porous support maintains its desired protein adsorption characteristics.

When grafting thermally responsive polymers, residual methacrylate groups can be supplemented with additional vinyl or allylic groups in order to improve grafting yield of LCST containing polymers (lower critical solution temperature). (See for example, U.S. Pat. No. 5,929,214 to Peters), the disclosure of which is hereby incorporated by reference. However, these modifications were accomplished on a support having convective pores (>1 μm), wherein the goal was “gating” convective flow with temperature changes and the grafted LCST polymers. In order to achieve flow reduction in micrometer size pores, the grafted chains must be of significant length and density to “fill” or “plug” the pores of this size. As taught in U.S. Pat. No. 5,135,650 to Hjerten, (the disclosure of which is hereby incorporated by reference), this grafting method essentially fills or plugs the pores LCST polymers are used for hydrophobic interaction chromatography (HIC), and because LCST polymers demonstrate a strong temperature dependence on binding behavior, their overall practical application in porous chromatography is limited.

In order to create surface modifications by minimizing extender chain length, strategies have been employed which use surface reactive groups and monomers which readily undergo degradative chain transfer. This combination of allylic surface reactive groups and allylic monomers is advantageous in order to minimize extender chain length.

The addition of polymer extenders to porous material surfaces provide improved protein binding capacity and desired potential changes in resin selectivity. However, as protein separations become more demanding, it becomes more critical to develop new technologies and methods in order to create novel polymer structures. Accordingly, it would be desirable to develop improved protein binding capacity and modify resin selectivity of porous substrates used in protein separation.

### SUMMARY OF THE INVENTION

In response to the above needs for new porous substrates, useful for protein separations, having improved protein binding capacity and resin selectivity, and the problems associated with grafting polymer extenders onto porous substrates having diffusive pores, a new method for grafting polymer extenders onto porous substrates have diffusive pores has been developed.

Thus, in accordance with the present invention, a new grafting method for coupling polymer extenders onto porous substrates having diffusive pores has been developed, resulting in the substrate having improved protein binding capacity and/or binding selectivity, without plugging or filling the diffusive pores of the porous substrate.

The present invention provides, at least in part, a new method for grafting polymer extenders onto porous substrates having diffusive pores and surface reactive unsaturated groups coupled to the surface of the substrates, including radical grafting to surface reactive groups that readily undergo degradative chain transfer.

According to another embodiment, the present invention is based, at least in part, on a new method for grafting polymer extenders onto porous beads having diffusive pores and used in protein separations and the like, resulting in the beads having improved protein binding capacity and desired resin selectivity.

In yet other embodiments, the present invention is based, at least in part, on grafting polymer extenders onto porous polymeric chromatography beads, porous agarose chromatography beads and porous ceramic chromatography beads.

According to another embodiment, the present invention is based, at least in part, on grafting polymer extenders onto porous substrates having diffusive pores having a pore size greater than about (>)100 Å and less than about (<) about 1 μ.

According to another embodiment, the present invention is based at least in part, on a new method for grafting polymer extenders onto porous substrates having diffusive pores and surface reactive functionalities, comprising the following steps:

a) providing a porous chromatography bead having diffusive pores and surface reactive functionalities coupled thereto;

b) providing a solution comprising grafting monomers or a mixture of grafting monomers, and a soluble radical polymerization initiator;

c) contacting the chromatography bead with the solution;

d) initiating free radical polymerization between the surface reactive functionalities on the bead and the grafting monomers or mixture of grafting monomers by the introduction of the radical polymerization initiator in the solution to form polymer chain extenders coupled to the bead;

e) washing the bead to remove any excess unreacted grafting monomers, mixtures of grafting monomers, or unattached polymer chains, resulting in a porous substrate having a protein binding capacity greater than 100 g/L; and

f) coupling ligands to the polymer chains attached to the chromatography bead surface.

According to an additional embodiment, the present invention is based, at least in part, on a new method for grafting polymer extenders onto porous substrates having diffusive pores wherein the grafting monomers or mixture of grafting monomers include methacrylates, acrylates, acrylamides, acrylic acid, 2-acrylamido-2-methyl-1-propanesulfonic acid. [3-(methacryloylamino) propyl] trimethylammonium chloride, 2-acrylamido-glycolic acid, itaconic acid or ethyl vinyl ketone, glycidyl methacrylate, N,N-Dimethylacrylamide, acrylamide, hydroxypropyl methacrylate, N-phenylacrylamide, hydroxylpropyl acrylamide, and combinations thereof.

According to another embodiment, the present invention is based, at least in part, on a new method for grafting polymer extenders onto porous substrates, wherein ligands, coupled to the polymer chain extenders include strong cation exchange groups, sulphopropyl groups, sulfonic acid groups, anion exchange groups, trimethylammonium chloride groups, weak cation exchange groups, carboxylic acid groups, weak anion exchange groups, N,N diethylamino groups, DEAE groups, hydrophobic interaction groups, phenyl groups, butyl groups, and propyl groups, and affinity groups. Protein A, Protein G, and Protein L, and combination thereof.

In certain other embodiments the present invention is based, at least in part, on a new method for grafting polymer extenders onto porous substrates, wherein the linker coupling the surface reactive functionalities to the porous substrate surface includes methacrylate, amides, acrylamides, epoxides, amines, butanediol diglycidyl ether, epichlorohydrin, polyethylenediol diglycidyl ether, ehtylenediol diglycidyl ether, allyl chloroacetate, allyl chloride, allyl(chloro)dimethylsilane,allyl glycidyl ether, allyl bromide, allyl methacrylate, and combinations thereof.

According to an additional embodiment, the present invention is based, at least in part, on a new method for grafting polymer extenders onto porous substrates having diffusive pores and surface reactive unsaturated functionalities, wherein the unsaturated functionalities are allylic groups.

In still other embodiments the present invention provides, at least in part, a new method for grafting polymer extenders onto porous substrates using a radical polymerization initiator including ammonium persulfate, potassium persulfate, azobis(4-cyanovaleric acid, Irgacure® 2959, 2,2′-azobis(2-amidino-propane)hydrochloride and combinations thereof.

Another object of thee present invention is to provide kits and methods relating to making and using the new method for grafting polymer extenders onto porous substrates having diffusive pore, used in protein separations, resulting in improved protein binding capacity and desired resin selectivity.

Additional features and advantages of the invention will be set forth in the detailed description and claims, which follows. Many modifications and variations of this invention can be made without departing from its spirit and scope, as will be apparent to those skilled in the art. It is to be understood that the foregoing general description and the following detailed description, the claims, as well as the appended drawings are exemplary and explanatory only, and are intended to provide an explanation of various embodiments of the present teachings. The specific embodiments taught herein are offered by way of example only and are not meant to be limiting to any way.

### DESCRIPTION OF THE EMBODIMENTS

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about”.

Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective lasting measurements. Moreover, all ranges taught herein are to be understood to encompass all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

Before describing the present invention in further detail, a number of terms will be defined. Use of these terms does not limit the scope of the invention but only serve to facilitate the description of the invention.

As used herein, the singular forms “a,” “an” and “the” include plural referents unless the context clearly dictates otherwise.

“Degradative chain transfer” chain transfer occurs when the propagating radical is very reactive, but the chain transfer product with the monomer is not reactive (forms stable radical). (See, “Principles of Polymerization”, George Odian, John Wiley-Sons Inc. New York, 1991), the disclosure of which is hereby incorporated by reference. This chain transfer results in greatly reduced polymerization rates and polymer molecular weight. This is advantageous in grafting when low molecular weight surface modification is desired (See, for example, U.S. Pat. Nos. 7,048,858 and 7,060,187, each to Ihre) However, when more reactive monomers are used, the surface reactive group becomes the chain termination anchor for longer extenders or tentacles in a “grafting polymer to” approach when the polymer is formed in situ. These in situ generated extenders provide improved binding capacity and modified selectivity. The method is advantageous because it can be used with a wide range on monomers, such as acrylates, acrylamides, methacrylates, and a wide range of substrates or base matrices (such as polymeric beads, agarose beads and ceramic beads).

Other “porous substrates” or “base matrices” that can be used herein include, but are not limited to, any material with diffusive pores and allylic surface reactive groups. Preferred materials for porous substrates or base matrices that can be used herein include polysaccharides, synthetic polymer, agarose, cellulose, polymethacrylates, polyacrylates, polyacrylamides, polystyrene which contain allyl methacrylate or the like, and hybrids or combinations of the aforementioned. Most preferred materials include agarose modified with allylic surface reactive groups, polymethylacrylate materials containing allylic surface reactive groups, polymethylacrylate materials modified with allylic surface reactive groups, and polymethacrylate materials which incorporate allyl methylmethacrylate.

Examples of “functional groups” that can be used herein include, but are not limited to, ion exchange groups, bioaffinity groups, hydrophobic groups, thiophilic interaction groups, chelate or chelating groups, groups having so called pi-pi interactions with target compounds, hydrogen bonding groups, and hydrophilic groups.

Examples of “ligands” that can be used herein include, but are not limited to, ion exchange groups, hydrophobic interaction groups, hydrophilic interaction groups, thiophilic interactions groups, metal affinity groups, affinity groups, bioaffinity groups, and mixed mode groups (combinations of the aforementioned). Some preferred ligands that can be used herein include, but are not limited to, strong cation exchange groups, such as sulphopropyl, sulfonic acid; strong anion exchange groups, such as trimethylammonium chloride; weak cation exchange groups, such as carboxylic acid; weak anion exchange groups, such as N,N diethylamino or DEAE: hydrophobic interaction groups, such as phenyl, butyl, propyl, hexyl; and affinity groups, such as Protein A, Protein G, and Protein L.

Examples of “radical polymerization initiators” that can be used herein include, but are not limited to, ammonium persulfate, potassium persulfate, azobis(4-cyanovaleric acid, Irgacure® 2959 (Ciba-Geigy, Hawthorn, N.Y.), 2,2′-azobis(2-amidino-propane)hydrochloride and the like. The grafting to reaction can be initiated with methods know in the art, preferably thermal initiation (heating) or UV irradiation.

Examples of “surface reactive unsaturated groups or functionalities” that can be used herein include, but are not limited to, allylic groups. A preferred surface reactive unsaturated functionalities includes allylic groups having the formula R—O—CH₂—CH═CH₂, where R is the porous substrate surface or a linker between the surface and the allylic groups.

Examples of “linkers” that can be used herein include, but are not limited to, molecules that contain groups that undergo high levels of degradative chain transfer during radical polymerization. Linkers that can be used herein also include, molecules or functionalities that have considerable stability to caustic solutions, such as compounds containing ether linkages, methacrylate, amide, acrylamide, epoxide, amine and the like. Preferred linkers such as butanediol diglycidyl ether, epichlorohydrin, polyethylenediol diglycidyl ether, ehtylenediol diglycidyl ether can be further modified with allyl containing groups such as allyl glycidyl ether using methods know in the art. Preferred linkers include allyl chloroacetate, allyl chloride, allyl(chloro)dimethylsilane, allyl glycidyl ether, allyl bromide and allyl methacrylate. Most preferred linkers include allyl glycidyl ether, allyl bromide and allyl methacrylate.

Examples of “grafting monomers” or “mixture of grafting monomers” that can be used herein include, but are not limited to, methacrylates, acrylates, and acrylamides. The most preferred grafting monomers include, but are not limited to, acrylic acid, 2-acrylamido-2-methyl-1-propanesulfonic acid, [3-(methacryloylamino) propyl] trimethylammonium chloride, 2-acrylamido-glycolic acid, itaconic acid or ethyl vinyl ketone, glycidyl methacrylate, N,N-Dimethylacrylamide, acrylamide, hydroxypropyl methacrylate, N-phenylacrylamide, hydroxylpropyl acrylamide, and combinations thereof.

In typical grafting approaches, either the residual unsaturation maintains reactivity towards further polymerization or the surface initiation requires carefully controlled conditions. For example, attachment of a acrylate functionality to a surface allows for a growing polymer chain to react with the surface and then continue to grow, making the place the extender attaches to the surface essentially random. For example, a polymerizing chain can react at the surface group during any point of its chain growth and continue to grow, thus incorporating the surface reactive group randomly along the extender. In the case of surface initiation, such as metal oxidation of hydroxyl groups, the solution conditions must be controlled to maintain the metal's active oxidation state and avoid quenching the surface activate reaction.

In the grafting method taught herein, these two these two deficiencies are overcome, the polymerization of the polymer extender is imitated in solution under less restrictive conditions and attachment to the surface of the porous substrate is more likely to be terminal as the degradative chain transfer of the surface reactive group acts much like an inhibitor, ending the polymer chain growth. (See, “Principles of Polymerization”. George Odian, John Wiley-Sons Inc. New York, 1991), the disclosure of which is hereby incorporated by reference.

Grafting to allylic surface reactive groups, which undergo degradative chain transfer, is known for monoliths, cellulose fibers and silica particles. However, known modifications to monoliths, cellulose fibers and silica particles was accomplished on convective pores (>1 μm) which are much larger than the diffusive pores found in bead based technologies. The cellulose and silica particles were modified and then configured info a porous structure having large convective pores.

Modification of the material with extenders prior to porous structure formation is not advantageous nor readily applicable to bead based technologies because it desirable to have the extender only at the surface of the internal structure/surface area (where the ligands can interact with the target molecule). Modification of particles (such as cellulose and silica) by the formation of porous structures from these modified particles result in plugged convective pores and a random distribution of the extenders, thus providing a limited, but much reduced ligand to target molecule interaction.

Additionally, the incorporation of grafted extenders onto a bulk porous structure (i.e., grafting extenders before bead formation) can compromise or change the material's mechanical properties and pore morphology. Monolith modifications result in pore restrictions (reduction of flow) in micrometer size pores. These observed pore restrictions suggest a monolith having polymer extender modifications which completely fill or plug smaller diffusive monolith pores provided.

Hjerten, as previously referenced, teaches an agarose matrix having pores that were completely plugged by the grafting of polymerized polyacrylate, such that protein diffusion in the pore was eliminated, enabling the use of the materials for non-porous bead applications such as analytical HPLC in the inventive method as taught herein, combinations of surface reactive group density, initiator concentration and monomer concentrations which improve binding capacity, can alter selectivity and create novel separation resins.

### EXAMPLES

### Example 1A

### Modification of a Polysaccharide Resin with a Surface Reactive Group and Cation Exchange Extenders

Agarose beads (Sepharose 4B) (GE Healthcare, Piscataway N.J.) were crosslinked using epichlorohydrin according to the teachings of Porath and Fornstedt, “Group Fractionation of Plasma Proteins on Dipolar Ion Exchangers”, (Journal of Chromatography: vol. 51, 1970, pp. 479-489), disclosure of which is hereby incorporated by reference. The beads were then modified with a surface reactive group, allyl glycidyl ether (AGE) according to the following method: In a jar, 10 ml of beads were added to 18 g of 8M NaOH, 4 g of AGE, 3g of Na₂SO₄ and then agitated overnight at 50° C. The beads were then washed with 500 ml of Milli-Q® water and filtered into a wet cake. The wet cake was added to a 20 ml solution containing 2.4 grams of 2-acrylamido-2-methyl-1-propanesulfonic acid, 17.3 g of Milli-Q® water, 0.2 g of N,N-Dimethylacrylamide and 0.12 grams of Irgacure® 2959 (CIBA) in a plastic bag. The plastic bag was placed between two polyethylene sheets. The polyethylene sandwich is then taped to a transport unit which conveys the assembly through a Fusion Systems UV exposure lab unit with an “H” bulb. Time of exposure is controlled by how fast the assembly moves through the UV unit. In this example, the assembly moves through the UV chamber at 15 feet per minute. The assembly is allowed to sit for five minutes before the bag is removed and the heads filtered and washed with 500 ml of Milli-Q® wafer. The equilibrium protein binding capacity measured according to the method in example 6 is shown in Table 1.

### Example 1B

### Modification of an Polysaccharide Resin without a Surface Reactive Group and Cation Exchange Extenders

Agarose beads (Sepharose 4B) (GE Healthcare, Piscataway N.J.) were crosslinked using epichlorohydrin according to the teachings of Porath and Fornstedt, “Group Fractionation of Plasma Proteins on Dipolar Ion Exchangers”; (Journal of Chromatography, vol. 51, 1970, pp. 479-489)

The beads were then washed with 500 ml of Milli-Q® water and filtered into a wet cake. The wet cake was added to a 20 mL solution containing 2.4 grams of 2-acrylamido-2-methyl-1-propanesulfonic acid, 17.3 g of Milli-Q® water, 0.2 g of N,N-Dimethylacrylamide and 0.12 grams of Irgacure® 2959 (CIBA) in a plastic bag. The plastic bag was placed between two polyethylene sheets. The polyethylene sandwich is then taped to a transport unit which conveys the assembly through a Fusion Systems UV exposure lab unit with an “H” bulb. Time of exposure is controlled by how fast the assembly moves through the UV unit. In this example, the assembly moves through the UV chamber at 15 feet per minute. The assembly is allowed to sit for five minutes before the bag is removed and the beads filtered and washed with 500 mL of Milli-Q® water. The equilibrium protein binding capacity measured according to the method in example 6 is shown in Table 1.

### Example 1C

### Modification of a Polysaccharide Resin with a Surface Reactive Group and Anion Exchange Extenders

Agarose beads (Sepharose 4B) (GE Healthcare, Piscataway N.J.) were crosslinked using epichlorohydrin according to the teachings of Porath and Fornstedt, “Group Fractionation of Plasma Proteins on Dipolar Ion Exchangers”, (Journal of Chromatography, vol. 51, 1970, pp. 479-489). The beads were then modified with a surface reactive group, allyl glycidyl ether (AGE) according to the following method: In a jar, 10 mL of beads were added to 18 g of 1M NaOH, 12 g of AGE. 3 g of Na₂SO₄ and then agitated overnight at 50° C. The beads were then washed with 500 ml of Milli-Q® water and filtered into a wet cake. The wet cake was added to a solution containing 6 grams of 75% (3-acrylamidopropyl)trimethylammonium chloride solution, 13.6 grams of Milli-Q® water and 0.2 grams of ammonium persulfate. The mixture was agitated at 65° C. for 17 hours. The beads were then washed with 500 mL of Milli-Q® water. The equilibrium protein binding capacity measured according to the method in example 6 is shown in Table 1.

### Example 1D

### Modification of a Polysaccharide Resin with Surface Reactive Groups and Cation Exchange Extenders with Optimum Binding at Low Ionic Strength

Agarose beads (Sepharose 4B) (GE Healthcare, Piscataway N.J.) were crosslinked using epichlorohydrin according to the teachings of Porath and Fornstedt, “Group Fractionation of Plasma Proteins on Dipolar Ion Exchangers”, (Journal of Chromatography, vol. 51, 1970, pp. 479-489). The beads were then modified with a surface reactive group, allyl glycidyl ether (AGE) according to the following method: In a Jar, 10 mL of beads were added to 18 g of 1M NaOH, 2.4 g of AGE, 3 g of Na₂SO₄ and then agitated overnight at 50° C. The beads were then washed with 500 mL of Milli-Q® water and filtered into a wet cake. The wet cake was added to a 20 mL solution containing 1 gram of 2-acrylamido-2-methyl-1-propanesulfonic acid, 18.8 g of Milli-Q® water, 0.15 g of N,N-Dimethylacrylamide and 0.08 g of ammonium persulfate in a jar. The jar was agitated and heated to 65° C. for 1 hour. The beads were filtered and washed with 500 mL of Milli-Q® water. The equilibrium protein binding capacity measured according to the method in example 6 is shown in Table 1.

### Example 1E

### Modification of a Polysaccharide Resin with Surface Reactive Groups and Cation Exchange Extenders with Optimum Binding at High Ionic Strength

Agarose beads (Sepharose 4B) (GE Healthcare, Piscataway N.J.) were crosslinked using epichlorohydrin according to the teachings of Porath and Fornstedt, “Group Fractionation of Plasma Proteins on Dipolar Ion Exchangers”, (Journal of Chromatography, vol. 51, 1970, pp. 479-489). The beads were then modified with a surface reactive group, allyl glycidyl ether (AGE) according to the following method: In a jar, 10 mL of beads were added to 18 g of 1M NaOH. 12 g of AGE, 3 g of Na₂SO₄ and then agitated overnight at 50° C. The beads were then washed with 500 mL of Milli-Q® water and filtered into a wet cake. The wet cake was added to a 20 mL solution containing 2 grams of 2-acrylamido-2-methyl-1-propanesulfonic acid, 17.8 g of Milli-Q® water, 0.2 g of N,N-Dimethylacrylamide and 0.08 g of ammonium persulfate in a jar. The jar was agitated and heated to 65° C. for 1 hour. The beads were filtered and washed with 500 mL of Milli-Q® water. The equilibrium protein binding capacity measured according to the method in example 6 is shown in Table 1.

TABLE 1
Equilibrium Binding Capacity for Agarose Beads

| | | Surface | | | |
|---|---|---|---|---|---|
| | | Reactive | Protein Static Capacity (g/L) | | |
| | | Group | IgG | IgG | |
| | | umol/mL | (pH 5, | (pH 5, | BSA |
| Example | Resin Type | of resin | 8 mS) | 16 mS) | pH 8, 4 mS |
| 1A | CIEX | 73 | 100 | | |
| 1B | CIEX | 0 | 11 | | |
| 1C | AIEX | 100 | | | 199 |
| 1D | CIEX | N.D. | 165 | 120 | |
| 1E | CIEX | N.D. | 100 | 175 | |
| Control | Fractogel-S | | 123 | 105 | |

N.D. = Not Determined

### Example 2A

### Modification of a Synthetic Polymer Resin with Surface Reactive Groups and Cation Exchange Extenders Optimum Binding at Low Ionic Strength

Polymethacrylate beads, 50 mL, (HW-65, 45 μm, TOSOH BioScience) were soaked in 1 M NaOH for 2 hrs at 25 ° C. and then washed with 500 mL of Milli-Q® water. The beads were then modified with a surface reactive group, allyl glycidyl ether (AGE) according to the following method: In a jar 15 mL beads, 18 g of 1M NaOH, 2.4 g AGE, 3 g Na2SO4 were added and agitated overnight at 50° C. The beads were washed with 500 mL of Milli-Q® water and filtered into a wet cake. Then 10 mL of wet cake was added to a solution containing 1.2 gram of 2-acrylamido-2-methyl-1-propanesulfonic acid, 0.08 g of ammonium persulfate. 18.5 g of Milli-Q® water and 0.24 g of N,N-Dimethylacrylamide in a jar. The jar was agitated and heated to 65° C. for 1 hour. The beads were filtered and washed with 500 ml of Milli-Q® water. The equilibrium protein binding capacity measured according to the method in example 6 is shown in Table 2.

### Example 2B

### Modification of a Synthetic Polymer Resin with Surface Reactive Groups and Cation Exchange Extenders Optimum Binding at High Ionic Strength

Polymethacrylate beads, 50 mL (HW-65, 45 μm. TOSOH BioScience) were soaked in 1 M NaOH for 2 hrs at 25° C. and then washed with 500 mL of Milli-Q® water. The beads were then modified with a surface reactive group, allyl glycidyl ether (AGE) according to the following method: In a jar 15 mL beads, 18 g of 1M NaOH. 2.4 g AGE. 3 g Na2SO4 were added and agitated overnight at 50° C. The beads were washed with 500 mL of Milli-Q® water and filtered into a wet cake. Then 10 mL of wet cake was added to a solution containing 2.8 gram of 2-acrylamido-2-methyl-1-propanesulfonic acid. 0.08 g of ammonium persulfate, 17 g of Milli-Q® water and 0.12 g of N,N-Dimethylacrylamide in a jar. The jar was agitated and heated to 65° C. for 1 hour. The beads were filtered and washed with 500 mL of Milli-Q® water. The equilibrium protein binding capacity measured according to the method in example 6 is shown in Table 2.

### Example 2C

### Modification of an Synthetic Polymer Resin without Cation Exchange Extenders

Polymethacrylate beads, 50 mL, (HW-65, 45 μm, TOSOH BioScience) were soaked in 1 M NaOH tor 2 hrs at 25° C. and then washed with 500 mL of Milli-Q® water. The beads were then modified with a surface reactive group, allyl glycidyl ether (AGE) according to the following method: In a jar 15 mL beads, 18 g of 1M NaOH, 2.4 g AGE, 3 g Na2SO4 were added and agitated overnight at 50° C. The beads were washed with 500 mL of Milli-Q® water and filtered into a wet cake. The surface reactive groups were turned into a standard cation exchange functionality by the following method: In a jar, 6 g beads, 4.7 ml of Milli-Q® water, 0.8 g of 50% wt NaOH and 2.3 g sodium meta-bisulfate were added and agitated overnight at room temperature. The beads were washed with 3×500 ml of Milli-Q® quality water. This procedure created a no extender control resin where the protein binding is possible to the surface of the resin, but there are no extenders or grafted chains available. The equilibrium protein binding capacity measured according to the method in example 6 is shown in Table 2.

### Example 2D

### Modification of an Synthetic Polymer Resin with Surface Reactive Groups and Anion Exchange Extenders

Polymethacrylate beads, 20 mL, (HW-65, 45 μm, TOSOH BioScience) were soaked in 1 M NaOH for 2 hrs at 25° C. and then washed with 500 mL of Milli-Q® water. The beads were then modified with a surface reactive group, allyl glycidyl ether (AGE) according to the following method: In a jar 15 mL of beads, 18 g of 1M NaOH, 2.4 g AGE, 3 g Na2SO4 were added and agitated overnight at 50° C. The beads were washed with 500 mL of Milli-Q® water and filtered into a wet cake. Then 10 mL of wet cake was added to a solution containing 6 grams of 75% 3-acrylamidopropyl)trimethylammonium chloride solution. 0.12 grams of ammonium persulfate and 13.6 g of Milli-Q® water in a jar. The jar was agitated and heated to 65° C. for 1 hour. The beads were filtered and washed with 500 mL of Milli-Q® water. The equilibrium protein binding capacity measured according to the method in example 6 is shown in Table 2

### Example 2E

### Modification of an Synthetic Polymer Resin without Surface Reactive Groups and without Extenders to create a Standard Anion Exchange Resin

Polymethacrylate beads, 10 mL, (HW-65, 45 μm, TOSOH BioScience) were soaked in 1 M NaOH for 2 hrs at 25° C. and then washed with 500 mL of Milli-Q® water and filtered into a wet cake. The wet cake was added to a solution containing 6 grams of 75% (3-acrylamidopropyl)trimethylammonium chloride solution, 0.12 grams of ammonium persulfate and 13.6 g of Milli-Q® water in a jar. The jar was agitated and heated to 65° C. for 1 hour. The beads were filtered and washed with 500 mL of Milli-Q® water. This procedure created a no extender control resin where the protein binding is possible to the surface of the resin, but there are no extenders or grafted chains available. The equilibrium protein binding capacity measured according to the method in example 6 is shown in Table 2

TABLE 2
Equilibrium Binding Capacity for Synthetic Polymer Beads

| | | Surface | | | |
|---|---|---|---|---|---|
| | | Reactive | Protein Static Capacity (g/L) | | |
| | | Group | IgG | IgG | |
| | | umol/mL | (pH 5, | (pH 5, | BSA |
| Example | Resin Type | of resin | 8 mS) | 16 mS) | pH 8, 4 mS |
| 2A | CIEX | 159 | 99 | 41 | |
| 2B | CIEX | 159 | 45 | 92 | |
| 2C | CIEX | 159 | 34 | 19 | |
| 2D | AIEX | 159 | | | 152 |
| 2E | AIEX | 0 | | | 36 |

Examples 2A-2D demonstrate the method can be applied to more than one type of base matrix, here polymethacrylate vs. agarose in Example 1, with a similar improvements in capacity. For both cation and anion exchange extenders, capacities 2-3× higher were observed for grafting extenders to the allylic surface reactive group. In addition, the capacities for Examples 1D and 1E are higher than a “state of the art” extender modified resin, Fractogel® S. This demonstrates the diffusion of large proteins, such as IgG, is still possible with grafted extenders by this method and in fact the capacity is an improvement over the state of the art.

### Example 2F

### Modification of a Synthetic Polymer Resin with Surface Reactive Groups and Hydrophobic Interaction Extender

Polymethacrylate beads, 50 mL, (HW-65, 45 μm, TOSOH BioScience) were soaked in 1 M NaOH for 2 hrs at 25° C. and then washed with 500 mL of Milli-Q® water. The beads were then modified with a surface reactive group, allyl glycidyl ether (AGE) according to the following method: In a jar, 10 g beads, 18 g of 2M NaOH, 12 g AGE. 3 g Na₂SO₄ were added and agitated overnight at 50° C. The beads were washed with 500 mL of Milli-Q® water and filtered into a wet cake. Five grams of the wet cake was added to a solution containing 0.2 grams of N-Phenylacrylamide, 0.08 g of ammonium persulfate, 3.4 g of N,N-dimethyl acetamide (DMAC), 3.4 g of hexylene glycol, and 3 g of Milli-Q® water in a jar. The jar was agitated and heated to 80° C. for 17 hours. The beads were filtered and washed with 500 mL of Milli-Q® water. The equilibrium protein binding (IgG) capacity measured according to the method in example 6 was found to be 33 g/L.

### Example 2G

### Modification of a Synthetic Polymer Resin with Surface Reactive Groups and Hydrophobic Interaction Extender

Polymethacrylate beads, 50 mL, (HW-65, 45 μm, TOSOH BioScience) were soaked in 1 M NaOH for 2 hrs at 25° C. and then washed with 500 mL of Milli-Q® water. The beads were then modified with a surface reactive group, allyl glycidyl ether (AGE) according to the following method: In a jar, 10 g beads, 18 g of NaOH, 12 g AGE, 3 g Na₂SO₄ added and agitated overnight at 50° C. The beads were washed with 500 mL of Milli-Q® water and filtered into a wet cake. Five grams of the wet cake was added to a solution containing 0.2 grams of N-Phenylacrylamide, 0.08 g of ammonium persulfate, 3.4 g of N,N-dimethyl acetamide (DMAC), 3.4 g of hexylene glycol, and 3 g of Milli-Q® water in a jar. The jar was agitated and heated to 80° C. for 17 hours. The beads were filtered and washed with 500 mL of Milli-Q® water. The equilibrium protein binding (IgG) capacity measured according to the method in example 6 was found to be 40 g/L.

### Example 3A

### Asymmetric Agarose Bead with Unique Chemical Environments and Two Distinct Pore Size Regions

### Preparation of Internal Structure

Asymmetric agarose beads were made according to the method taught in US Patent Application Publication No. 2007/0212540; 1,000 ml of 15% agarose solution (D-5 Agarose from Hispanagar) was added to 2,000 ml of mineral oil containing 120 ml of Span 80 emulsifier in a first oil bath at 80° C. under constant agitation to obtain an emulsion in which the oil phase is continuous. The emulsion was then pumped through a 0.5 inch (12.7 mm) diameter, 6 inches (152.4 mm) long Kenics static mixer (KMR-SAN-12) at a flow rate of 3L/min into a second bath of mineral oil at 5° C. Spherical homogeneous agarose beads were obtained with a largest particle diameter of 200 μm. The beads were settled, washed with of water, ethanol and then water and sieved to yield a bead size range of 75 μm to 125 μm. The beads were then crosslinked according to the methods taught in Porath et al., “Agar derivatives for chromatography, electrophoresis and gel bound enzymes. Desulphated and reduced crosslinked agar and agarose in spherical bead form”. (Journal of Chromatography, vol. 60, 1971, pp. 167-177), the disclosure of which is hereby incorporated by reference. The beads were then modified with allyl glycidyl ether (AGE). In a jar, 120 g beads, 150 ml of 8M NaOH, 30 g sodium sulfate and 100 g of AGE were added and agitated overnight at 45° C. The beads were washed with 3×500 ml of Milli-Q® quality water. Selectivity testing results are shown in Table 3.

### Example 3B

### Asymmetric Agarose Seed with Unique Chemical Environments and Two Distinct Pore Size Regions; Internal Structure with Standard Cation Exchange Functionality

A portion of the beads made in Example 3A were modified to create a standard cation exchange material. The beads were modified with sodium meta-bisulfite. In a jar, 60 g beads, 47 ml of Milli-Q® water, 7.9 g of 50% wt NaOH and 23.4 g sodium meta-bisulfite were added and agitated overnight at room temperature. The beads were washed with 3×500 ml of Milli-Q® quality water.

The beads were then coated with 6% agarose according to the following method: 50 ml of the beads were then mixed into 300 ml of 6% agarose solution (D-5 Agarose from Hispanagar) to obtain a slurry. The agarose-beads mixture was added to 1000 ml of mineral oil at 90° C. under constant agitation to obtain an emulsion in which the oil phase is continuous. The emulsion was then pumped through a 0.5 inch (12.7 mm) diameter, 6 inches (152.4 mm) long Kenics static mixer (KMR-SAN-12) at a flow rate of 3L/min into mineral oil at 5° C. The resulting agarose beads had an estimated external layer thickness of 10 μm and the bead population was predominantly single-cored, (>50%). The beads were settled, washed with of water, ethanol and then water and sieved to yield a bead size range of 75-125 μm. The beads were crosslinked according to the method taught in Porath et al., “agar derivatives for chromatography, electrophoresis and gel bound enzymes. Desulphated and reduced crosslinked agar and agarose in spherical bead form”, (Journal of Chromatography, vol. 60, 1971, pp. 167-177), the disclosure of which is hereby incorporated by reference. The beads were washed with 3×500 ml of Milli-Q® quality water.

The beads were then modified with bromopropane sulfonic acid (BPSA). In a jar, 10 g beads, 30 ml of 5M NaOH, 7.2 g BPSA were added and agitated overnight at 50° C. The beads were washed with 500 ml of Milli-Q® quality water and then stored in 20% ethanol. Selectivity testing results are shown in Table 3.

### Example 3C

### Asymmetric Agarose Bead with Unique Chemical Environments and Two Distinct Pore Size Regions: Internal Structure with Inventive Method; Cation Exchange Extenders with Improved Binding Strength/Selectivity

A portion of the beads made in Example 3A were modified to create cation exchange extenders with improved binding strength/selectivity. The beads were washed with 500 mL of Milli-Q® water and filtered into a wet cake. The wet cake (10 mL) was added to a 20 mL solution containing 2.4 grams of 2-acrylamido-2-methyl-1-propanesulfonic acid, 17.3 g of Milli-Q® water, 0.2 g of N,N-Dimethylacrylamide and 0.12 grams of Irgacure®0 2959 (CIBA) a plastic bag. The plastic bag was placed between two polyethylene sheets. The polyethylene sandwich is then taped to a transport unit which conveys the assembly through a Fusion Systems UV exposure lab unit with an “H” bulb. Time of exposure is controlled by how fast the assembly moves through the UV unit. In this example, the assembly moves through the UV chamber at 15 feet per minute. The assembly is allowed to sit for five minutes before the bag is removed and the beads filtered and washed with 500 mL of Milli-Q® water.

The beads were then coated with 6% agarose according to the following method: 50ml of the beads were then mixed into 300 ml of 6% agarose solution (D-5 Agarose from Hispanagar) to obtain a slurry. The agarose-beads mixture was added to 1000 ml of mineral oil at 90° C. under constant agitation to obtain an emulsion in which the oil phase is continuous. The emulsion was then pumped through a 0.5 inch (12.7 mm) diameter; 6 inches (152.4 mm) long Kenics static mixer (KMR-SAN-12) at a flow rate of 3L/min into mineral oil at 5° C. The resulting agarose beads had an estimated external layer thickness of 10 μm and the bead population was predominantly single-cored (>50%). The beads were settled, washed with of water, ethanol and then water and sieved to yield a bead size range of 75 to 125 μm. The beads were crosslinked according to the method taught in Porath et al., “Agar derivatives for chromatography, electrophoresis and gel bound enzymes. Desulphated and reduced crosslinked agar and agarose in spherical bead form”, (Journal of Chromatography, vol. 60, 1971, pp. 167-177), the disclosure of which is hereby incorporated by reference. The beads were washed with 3×500 ml of Milli-Q® quality water.

The beads were then modified with bromopropane sulfonic acid (BPSA), in a jar, 10 g beads, 30 ml of 5M NaOH, 7.2 g BPSA were added and agitated overnight at 50° C. The beads were washed with 500 ml of Milli-Q® quality water and then stored in 20% ethanol. Selectivity testing results are shown in Table 3.

### Example 3D

### Asymmetric Agarose Seed with Unique Chemical Environments and Two Distinct Pore Size Regions: Internal Structure with Inventive Method; Cation Exchange Extenders with Improved Binding Strength/Selectivity

Beads from Example 3A were modified identically to Example 3C with an additional final modification step as follows. The beads were then modified with bromopropane sulfonic acid (BPSA). In a jar, 10 g beads, 30 ml of 5M NaOH, 7.2 g BPSA were added and agitated overnight at 50° C. The beads were washed with 500 ml of Milli-Q® quality water and then stored in 20% ethanol. Selectivity testing results are shown in Table 3.

### Example 3E

### Asymmetric Agarose Bead with Unique Chemical Environments and Two Distinct Pore Size Regions: Internal Structure with Inventive Method; Cation Exchange Extenders with Improved Binding Strength/Selectivity

Beads from Example 3A were modified identically to Example 3C with two additional final modification steps as follows: The beads were then modified with bromopropane sulfonic acid (BPSA). In a jar, 10 g beads, 30 ml of 5M NaOH, 7.2 g BPSA were added and agitated overnight at 50° C. The beads were washed with 500 ml of Milli-Q® quality water. The beads were then modified with bromopropane sulfonic acid (BPSA). In a jar, 10 g beads, 30 ml of 5M NaOH, 7.2 g BPSA were added and agitated overnight at 50° C. The beads were washed with 500 ml of Milli-Q® quality water and then stored in 20% ethanol. Selectivity testing results are shown in Table 3

TABLE 3
Selectivity of Asymmetric Agarose Beads

| | | | Peak |
|---|---|---|---|
| | IgG Peak | Lysozyme | Separation |
| Example | (CV) | Peak (CV) | (CV) |
| 3B | 19.7 | 25.7 | 6.6 |
| 3C | 18.2 | 28.3 | 10.1 |
| 3D | 20.4 | 29.8 | 9.4 |
| 3E | 20.6 | 29.7 | 9.1 |
| Control | 20.4 | 26.1 | 6.7 |
| SP- | | | |
| Sepharose | | | |
| Fast Flow | | | |

Examples 3C-3E teach an asymmetric agarose bead whose internal bead structure is modified according to the inventive method with the external structure being modified via a series of standard cation exchange methodologies. By comparison, Example 3B teaches an asymmetric agarose bead with the internal and external structure being modified by standard ion exchange methods.

Table 3 shows the separation between IgG and Lysozyme in terms of the column volumes (CV) needed to elute the proteins during a sodium chloride gradient elution. It is clear that Example 3B and SP-Sepharose Fast Flow, a commercial agarose resin, provide a similar separation between the two proteins.

However, Examples 3C-3E, with the internal structure containing the inventive method, provides a much improved separation of the two proteins.

### Example 4

### Selectivity Testing Method

Two proteins of different net charge and molecular weight were used to test the nature of the selectivity or separation factor under typical cation exchange (CEX) conditions. A mixture of a protein containing 0.5 mg/ml polyclonal IgG (Sigma) and 0.5 mg/ml lysozyme (Sigma) in 50 mM acetate buffer with NaCl to give conductivity 10 mS at pH 4.5 were applied to each sample column at 200 cm/hr (7 cm bed height, 0.66 cm diameter) such that the net protein loaded on the media was 10 mg/mL. The protein mixture was then eluted at 200 cm/hr using a 30 CV NaCl gradient starting at 10 mS and ending at 80 mS. The peak for each protein was recorded in terms of column volumes (CV) from the start of the elusion gradient (dead volume was corrected).

### Example 5

### Determination of Surface Reactive Group Concentration

After addition of the surface reactive group, allyl glycidyl ether (AGE), representative samples of the example modifications taught above were washed and titrated with aqueous bromine as follows. A mixture of 10% NaOBr (20 mL) and 50 mM Sodium acetate (80 mL, pH 4.5) was made. The bromine concentration ins solution was calibrated by titrating 100 μL of AGE in water. A 10 mL sample of surface modified bead was titrated with the bromine solution until the bromine color persisted which indicated complete reaction of the AGE surface groups.

### Example 6

### Determining the Equilibrium Protein Binding Capacity

The static or equilibrium capacity for each of the products taught in the examples above and commercial benchmarks were determined using the following method:
1. Bead suspensions (10% beads) were made out of each sample in the appropriate equilibration buffer (EQ buffer, see Table 4)
2. The bead suspensions were stirred and 100 μL samples were pipetted into three 15 ml plastic conical tubes
3. An appropriate protein solution (Feed, all proteins were polyclonal from Sigma-Aldrich, see Table 2) in EQ buffer was added to each tube (10 mL).
4. The tubes were capped and rotated slowly (<10 rpm) on an Labquake rotator/shaker.
5. After 16 hours the beads were allowed to settle and a UV reading was taken of the solution after binding.
6. The UV absorbance was converted into protein concentration using the appropriate extinction coefficient for the feed protein and the mass balance was used to determine the saturation capacity.

TABLE 4
Buffer conditions for equilibrium capacity experiments

| | | Feed for Static Capacity | |
|---|---|---|---|
| | | | Protein |
| | Equilibration Buffer | | Concentration |
| Buffer Type | EO and Feed | Protein | (g/L) |
| Cation Exchange Low Ionic Strength | 50 mM Sodium | IgG | 2.5 |
| | Acetate with NaCl, | | |
| | pH 5 | | |
| Cation Exchange High Ionic Strength | 50 mM Sodium | IgG | 2.5 |
| | Acetate with NaCl, | | |
| | pH 5 | | |
| Anion Exchange | 25 mM Tris, pH 8 | BSA | 4 |
| Hydrophobic Interaction (HIC) | 25 mM Phosphate with | IgG | 1 |
| | 0.8M Na₂SO₄, pH 7 | | |

The protein binding properties of the methods taught herein were examined for total protein capacity for several different binding conditions and protein separations. From the comparative examples 1A/1B, 2A/2C and 2D/2E it becomes apparent that the addition of an allylic surface reactive group improves the grafted polymer extender density such that the protein capacity improves significantly versus the no surface reactive group and/or no extender. In examples 1A/1B, the agarose bead capacity for IgG is about 10× higher, 100 g/L vs. 11/L, for the grafting to a surface reactive allyl group.

The methods taught herein also modify the resin's binding strength as demonstrated by the IgG capacity for Examples 1D/1E and 2A/2B.

Additionally, Examples 1D and 2A are designed to bind IgG at pH 5, 8 mS conductivity. Regardless of the base matrix, agarose or another synthetic polymer, the extender chemistry can be tuned to the particular binding condition. For certain protein publication processes, the desired binding conditions occur at higher salt concentrations, which can be problematic for some ion exchangers.

For example, the control resin (Fractogel®S) shows a reduction in binding capacity for IgG upon increasing the conductivity from 8 ms to 16 mS with sodium chloride. This is perhaps due to a decrease in the binding strength of the resin for IgG.

Using the grafting methods taught herein, a resins decreased binding capacity for IgG upon increasing the conductivity from 8 mS to 16 mS can be improved as demonstrated in Example 1E and 2B. Once again the binding properties of the resin can be tuned regardless of base matrix, creating high capacities at 16 mS conductivity, and enabling a >50% increase in binding capacity under those conditions. This enables the effective loading of IgG at higher conductivities which expands the buffer conditions one skilled in the art could use to separate proteins of interest from impurities.

The present invention can be used with any sample preparation methods including, but not limited to, chromatography; preparative protein chromatography electrophoresis; gel filtration; sample centrifugation; on-line sample preparation; diagnostic kits testing; diagnostic testing; transport of chemicals; transport of biomolecules; high throughput screening; affinity binding assays; purification of a liquid sample; size-based separation of the components of the fluid sample; physical properties based separation of the components of the fluid sample; chemical properties based separation of the continents of the fluid sample, biological properties based separation of the components of the fluid sample; electrostatic properties based separation of the components of the fluid sample; and, combinations thereof.

The invention also provides kits which may be used to increase the binding capacity of porous structures with diffusive pores by adding polymer extenders to the surface without filing or blocking the diffusive pores, and restricting diffusion of proteins and the like during protein separations. The polymer extenders added to the surface of porous structures provide significant binding capacity at higher conductivity.

The term “kit” includes, for example, each of the components combined in a single package, each of the components individually packaged and sold together, or each of the components presented together in a catalog (e.g., on the same page or double-page spread in the catalog).

The inventive grafting methods as taught herein can increase the binding capacity of porous structures with diffusive pores by adding extenders to the surface without filling the pore and restricting diffusion. The inventive grafting method as taught herein can also alter the resin's binding strength and selectivity, which are two critical resin properties needed for effective protein separations. As taught herein, this can be readily accomplished by changing the grafting conditions or monomer composition used. Finally the inventive grafting methods as taught herein can also produce extenders which have significant binding capacity at higher conductivity.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties taught herein. The following claims particularly point out certain combinations and subcombinations regarded as novel and non-obvious. Inventions embodied in other combinations and subcombinations of features, functions, elements, and/or properties may be claimed in applications claiming priority from this or a related application. Such claims, whether directed to a different invention or to the same invention, and whether broader, narrower, equal or different in scope to the original claims, also are regarded as included within the subject matter of the inventions of the present disclosure.

What is claimed is:

1. A method of modifying a porous substrate having diffusive pores and surface reactive unsaturated functionalities, said method comprising:
a) providing a porous substrate having diffusive pores and surface reactive unsaturated functionalities attached to the surface of the substrate.
b) providing a solution comprising a grafting monomer or a mixture of grafting monomers, and a soluble radical polymerization initiator;
c) contacting the substrate with the solution; and
d) initiating free radical polymerization between the surface reactive unsaturated functionalities on the surface of the substrate and the grafting monomors or mixture of grafting monomers by the introducing the free radical polymerization initiator in the solution to form polymeric chains coupled to the substrate.

2. The method of claim 1, wherein the substrate is selected from the group consisting of porous polymeric beads, porous agarose beads and porous ceramic beads.

3. The method of claim 1, further comprising after step (d):
e) washing the substrate to remove any excess unreacted grafting monomers, mixture of grafting monomers, or unattached polymer chains, resulting in a porous substrate having a protein binding capacity greater than 100 g/L.

4. The method of claim 3, further comprising after step (e):
f) coupling ligands to the polymer chains attached to the porous substrate surface.

5. The method of claim 1, wherein the radical polymerization initiator is selected from the group consisting of ammonium persulfate, potassium persulfate, azobis(4-cyanovaleric acid, Irgacure® 2959, 2,2′, azobis(2-amidino-propane)hydrochloride and combinations thereof.

6. The method of claim 1, wherein the unsaturated functionalities are comprised of allylic groups.

7. The method of claim 6, wherein the allylic groups are comprised of the formula R—O—CH₂—CH═CH₂, where R is the porous substrate surface or a linker between the surface and the allylic groups.

8. The method of claim 1, wherein about 20 μmol/mL to about 400 μmol/mL of surface reactive groups have the formula R—I—CG₂—CH═CH₂, where R is the porous substrate surface or a linker between the surface and the allylic groups, and the linkers are selected from the group consisting of methacrylate, amides, acrylamides, epoxides, amines, butanediol diglycidyl ether, epichlorohydrin, polyethylenediol diglycidyl ether, ethylenediol diglycidyl ether, allyl chloroacetate, allyl chloride, allyl(chloro)dimethylsilane, allyl glycidyl ether, allyl bromide, allyl methacrylate, and combinations thereof.

9. The method of claim 1, wherein the grafting monomers or mixture of grafting monomers are selected from the group consisting of methacrylates, acrylates, acrylamides, acrylic acid, 2-acrylamido-2-methyl-1-propanesulfonic acid, [3-(methacryloylamino)propyl] trimethylammonium chloride, 2-acrylamido-glycolic acid, itaconic acid or ethyl vinyl ketone, glycidyl methacrylate, N,N-Dimethylacrylamide, acrylamide, hydroxypropyl methacrylate, N-phenylacrylamide, hydroxylpropyl acrylamide, and combinations thereof.

10. The method of claim 1, wherein the diffusive pores on the porous substrate have a pore size >about 100 Å and <about 1 μ.

11. A method of modifying a porous chromatography bead having diffusive pores with surface polymer chain extenders, said method comprising:
a) providing a porous chromatography bead having diffusive pores, a surface, and surface reactive unsaturated functionalities coupled to the surface;
b) providing a solution comprising grafting monomers or a mixture of grafting monomers, and a soluble radical polymerization initiator.
c) contacting the chromatography bead with the solution;
d) initiating free radical polymerization between the surface reactive unsaturated functionalities on the bead and the grafting monomers or mixture of grafting monomers by the introduction of the radical polymerization initiator in the solution to form polymer chain extenders coupled to the bead.
e) washing the bead to remove any excess unreacted grafting monomers, mixture of grafting monomers, or unattached polymer chains resulting in a porous chromatography bead having a protein binding capacity greater than 100 g/L; and
f) coupling ligands to the polymer chains attached to the chromatography bead surface.

12. The method of claim 11, wherein the porous chromatography bead is selected from the group consisting of polymeric beads, agarose beads and ceramic beads.

13. The method of claim 11, wherein the radical polymerization initiator is selected from group consisting of ammonium persulfate, potassium persulfate, azobis(4-cyanovaleric acid, Irgacure® 2959, 2,2′-azobis(2-amidino-propane)hydrochloride and combinations thereof.

14. The method of claim 11, wherein the unsaturated functionalities are comprised of allylic groups.

15. The method of claim 14, wherein the allylic groups are comprised of the formula R—O—CH₂—CH═CH₂; where R is the porous substrate surface or a linker between the surface and the allylic groups.

16. The method of claim 11, wherein about 20 μmol/mL to about 400 μmol/mL of surface reactive groups have fro formula R—O—CH₂—CH═CH₂, where R is the porous chromatography bead or a linker between the surface of the bead and the allylic groups, and the linkers are selected from the group consisting of methacrylate, amides, acrylamides, epoxides, amines, butanediol diglycidyl ether, epichlorohydrin, polyethylenediol diglycidyl ether, ethylenediol diglycidyl ether, allyl chloroacetate, allyl chloride, allyl(chloro)dimethylsilane, allyl glycidyl ether allyl bromide, allyl methacrylate, and combinations thereof.

17. The method of claim 11, wherein the grafting monomers or mixture of grafting monomers are selected from the group consisting of methacrylates, acrylates, acrylamides and combinations thereof.

18. The method of claim 11, wherein the diffusive pores on the porous chromatography bead have a pore size>about 100 Å and<about 1 μ.

19. The method of claim 11, wherein the ligands are selected from the group consisting of strong cation exchange groups, sulphopropyl, sulfonic acid, anion exchange groups, trimethylammonium chloride, weak cation exchange groups, carboxylic acid, weak anion exchange groups, N,N diethylamino, DEAE, hydrophobic interaction groups, phenyl groups, butyl groups, and propyl groups, and affinity groups, Protein A, Protein G, and Protein L.

20. The method according to claim 7, wherein the linkers are selected from the group consisting of methacrylate, amides, acrylamides, epoxides, amines, butanediol diglycidyl ether, epichlorohydrin, polyethylenediol diglycidyl ether, ehtylenediol diglycidyl ether, allyl chloroacetate, allyl chloride, allyl(chloro)dimethylsilane, allyl glycidyl ether, allyl bromide, allyl methacrylate, and combinations thereof.

21. The method of claim 4, wherein the ligands are selected from the group consisting of strong cation exchange groups, sulphopropyl, sulfonic acid, anion exchange groups, trimethylammonium chloride, weak cation exchange groups, carboxylic acid, weak anion exchange groups, N,N diethylamino, DEAE, hydrophobic interaction groups, phenyl groups, butyl groups, and propyl groups, and affinity groups, Protein A, Protein G. and Protein L.

22. The method according to claim 15, wherein the linkers are selected from the group consisting of methacrylate, amides, acrylamides, epoxides, amines, butanediol diglycidyl ether, epichlorohydrin, polyethylenediol diglycidyl ether, ehtylenediol.
